(19) United States
(12) Patent Application Publication
(10) Pub. No.: US 2026/0222534 A1
(43) Pub. Date: Jul. 30, 2026

(54) DISPLAY CONTROL DEVICE AND DISPLAY CONTROL METHOD

(71) Applicant: Sony Interactive Entertainment Inc., Tokyo (JP)

(72) Inventor: Yoshio Miyazaki, Tokyo (JP)

(73) Assignee: Sony Interactive Entertainment Inc., Tokyo (JP)

(21) Appl. No.: 19/146,869

(22) PCT Filed: Jan. 26, 2023
(86) PCT No.: PCT/JP2023/002414

§ 371 Date: Jul. 9, 2025

(51) Int. Cl. H04N 13/398; G06F 3/16; H04N 13/00

(52) U.S. Cl. CPC H04N 13/398; G06F 3/165; H04N 2013/0085

(57) ABSTRACT

A VR event detection part 54 of a content processing apparatus 200 detects occurrence of an event set either for a self-object manipulable by a user in a VR space or for other objects therein. A real event detection part 56 detects occurrence of a predetermined event in the real world. According to the event that has occurred, a mode switchover part 62 switches an output target between a display image representing the VR space and a see-through image representing the real world. An output part 64 outputs the display image after the switchover to a head-mounted display 100.

### TECHNICAL FIELD

The present invention relates to a display control apparatus and a display control method for controlling display on a head-mounted display.

### BACKGROUND ART

There is widespread use of image display systems allowing a user wearing a head-mounted display to view a target space from a free viewpoint. For example, there is known electronic content of which the target space is a virtual three-dimensional space and which realizes virtual reality (VR) with images displayed on the head-mounted display in a manner reflecting the user's line-of-sight direction. Utilizing the head-mounted display can enhance the sense of immersion in the visual world and improve the operability of applications such as games. In addition, walk-through systems which allow the user wearing the head-mounted display and physically moving around to walk around virtually in a space displayed as imagery have also been developed.

The deeper the sense of immersion in the visual world, the harder it becomes for the user to focus on real-world situations. It might happen that the user has unwittingly moved to an unexpected position or remains unaware of the changing surroundings such an approaching person. In view of this, there have been proposed techniques which enable the head-mounted display to have a function of letting the real-world situation be viewed temporarily during display of content imagery, with a view to avoiding hazards and enhancing convenience (e.g., see PTL 1 and PTL 2).

### CITATION LIST

### Patent Literature

### [PTL 1]

PCT Patent Publication No. WO2017/022769

### [PTL 2]

Japanese Patent Laid-open No. 2018-10657

### SUMMARY

### Technical Problem

In recent years, VR technologies have been applied to diverse scenes of the real world, as testified by widespread use of the term “metaverse.” If such situations accelerate from now on, it might happen that the state of stay in a VR space becomes commonplace. The longer the period of staying in the VR space, the larger the number of scenes that require returning from the VR space to the real world will become, in addition to specific situations requiring a short-term avoidance of hazards during an electronic game. Thus, there is a need for technologies that permit a seamless alternation between the VR space and the real world without compromising the world view of the VR space.

The present invention has been made in view of the above circumstances. An object of the invention is therefore to provide a technology that implements the seamless alternation between the VR space and the real world without compromising the world view of the VR space.

### Solution to Problem

In solving the problem above and according to one embodiment of the present invention, there is provided a display control apparatus. This display control apparatus is characterized to include an output part configured to output data of an image representing a virtual space to a head-mounted display, a virtual event detection part configured to detect that a predetermined event related to a virtual object in the virtual space has occurred, and a mode switchover part configured to switch, upon occurrence of the event, an output target to be output by the output part from the data of the image representing the virtual space to data of a see-through image representing a real world.

According to another embodiment of the present invention, there is provided a display control method. This display control method is characterized to include a step of outputting data of an image representing a virtual space to a head-mounted display, a step of detecting that a predetermined event related to a virtual object in the virtual space has occurred, and a step of switching, upon occurrence of the event, an output target to be output by an output part from the data of the image representing the virtual space to data of a see-through image representing a real world.

It is to be noted that suitable combinations of the above constituent elements and the expressions of the present invention, when converted between a system, a computer program, a recording medium that records the computer program in a readable manner, and a data structure, among others, are also effective as embodiments of the present invention.

### Advantageous Effect of Invention

According to the present invention, it is possible to implement a seamless alternation between the VR space and the real world without compromising the world view of VR space.

### BRIEF DESCRIPTION OF DRAWINGS

FIG. 1 is an exemplary external view of a head-mounted display in an embodiment of the present invention.

FIG. 2 is a view depicting an exemplary configuration of an image display system in the present embodiment.

FIG. 3 is a view depicting an exemplary image displayed on the head-mounted display in the present embodiment.

FIG. 4 is a view depicting an internal circuit configuration of a content processing apparatus in the present embodiment.

FIG. 5 is a view depicting an internal circuit configuration of the head-mounted display in the present embodiment.

FIG. 6 is a view depicting functional blocks of the content processing apparatus in the present embodiment.

FIG. 7 is a view depicting a perceptive image of a manner of switchover from a VR space mode to a see-through mode, the switchover being triggered by an event in a VR space in the present embodiment.

FIG. 8 is a view depicting another example of a manner of switchover from the VR space mode to the see-through mode, the switchover being triggered by an event in the VR space in the present embodiment.

FIG. 9 is a view depicting an exemplary data structure of setting information stored as event setting information in the present embodiment.

FIG. 10 is a view depicting an exemplary setting screen displayed by an event setting processing part in the present embodiment for receiving event-related settings from a user.

FIG. 11 is a flowchart of processing steps performed by the content processing apparatus in the present embodiment for controlling switchover between the VR space mode and the see-through mode.

### DESCRIPTION OF EMBODIMENT

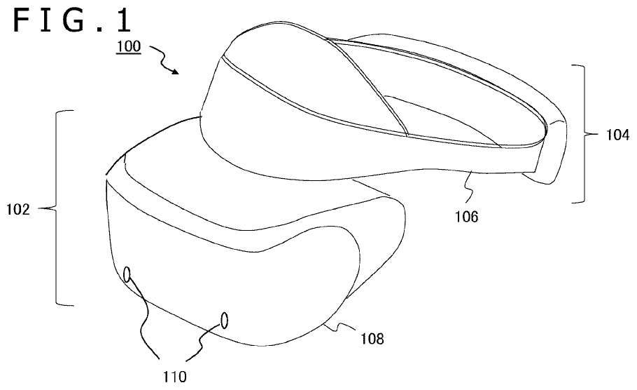

FIG. 1 is an exemplary external view of a head-mounted display 100. In this example, the head-mounted display 100 includes an output mechanism part 102 and a wearing mechanism part 104. The wearing mechanism part 104 includes a wearing band 106 worn by a user to secure an apparatus around the head. The output mechanism part 102 includes a housing 108 shaped to cover the left and right eyes of the user when the head-mounted display 100 is worn by the user. Inside the housing 108 is a display panel directly facing the eyes when the head-mounted display 100 is worn.

Also inside the housing 108 are eyepieces for magnifying images, the lenses being interposed between the display panel and the user's eyes when the head-mounted display 100 is worn. In addition, the head-mounted display 100 may further have speakers or earphones mounted at positions corresponding to the user's ears when the head-mounted display 100 is worn. Moreover, the head-mounted display 100 may incorporate motion sensors that detect translational and rotational motions of the user's head wearing the head-mounted display 100 and, by extension, the positions and postures of the head at different points in time.

The head-mounted display 100 is also equipped with a stereo camera 110 at the front of the housing 108. The present embodiment provides a mode in which moving images captured by the stereo camera 110 are displayed with a small delay to let the user view the unmodified real space in the user's facing direction. In the description that follows, this mode will be referred to as a “see-through mode.” For example, the head-mounted display 100 automatically enters see-through mode during a period in which content images are not displayed.

This allows the user to check the status of the surroundings before, after, and during interruption of content execution without taking off the head-mounted display 100. It is to be noted that, although the illustrated example indicates the stereo camera 110 being mounted at the lower front of the housing 108, the camera position is not limited to any specific arrangement. Also, cameras other than the stereo camera 110 may be mounted alternatively.

The images captured by the stereo camera 110 may also be used as content images. For example, a virtual object may be combined with captured images and displayed in a manner reflecting the position, posture, and motion of a real object in the field of view of the camera, thereby realizing augmented reality (AR) or mixed reality (MR). In addition, regardless of whether or not to include captured images into what is being displayed, it is also possible to analyze the captured images and determine the position, posture, and motion of the object to be rendered, through the use of the result of the analysis.

For example, captured images may be subjected to stereo matching to extract corresponding points of a subject from the images. The distance to the subject may then be obtained by use of the principle of triangulation. Alternatively, known techniques such as visual simultaneous location and mapping (SLAM) may be used to acquire the position and posture of the head-mounted display 100 relative to the surrounding space and, by extension, the position and posture of the user's head. Such processes permit rendering and display of a virtual world in a field of view reflecting the viewpoint position and line-of-sight direction of the user.

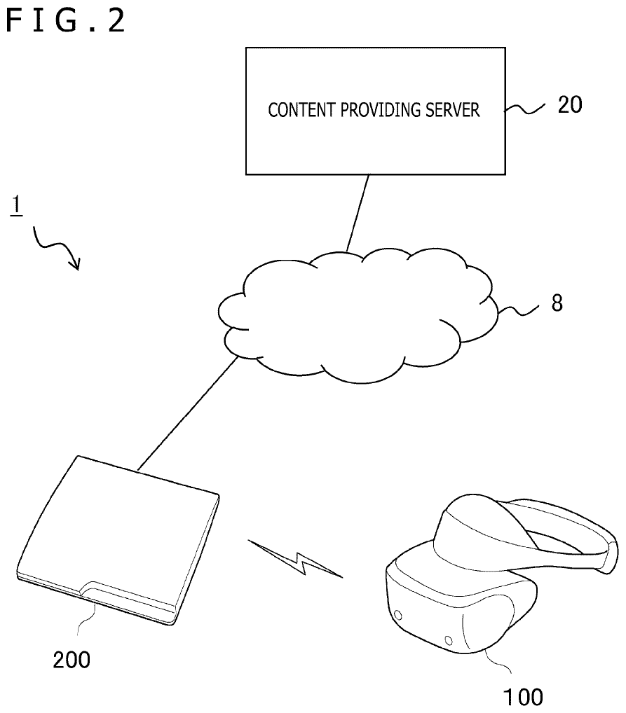

FIG. 2 is a view depicting an exemplary configuration of an image display system in the present embodiment. An image display system 1 includes the head-mounted display 100 and a content processing apparatus 200. The head-mounted display 100 is connected to the content processing apparatus 10 in a wired or wireless manner. The content processing apparatus 200 is connected by wire or wirelessly with a network 8, and is connected to a content providing server 20 via the network 8.

The content processing apparatus 200 is an information processing apparatus that basically generates display images by processing content and transmits the generated images to the head-mounted display 100 for display thereon. Typically, the content processing apparatus 200 identifies the viewpoint position and line-of-sight direction of the user on the basis of the position and posture of the user's head wearing the head-mounted display 100, and generates display images in a field of view reflecting the identified viewpoint direction and line-of-sight direction. For example, while advancing an electronic game, the content processing apparatus 200 generates and displays images representing a virtual world that constitutes a game stage.

It is to be noted that the details and display image viewpoints of the content processed by the content processing apparatus 200 are not limited to anything specific. Also, the content processing apparatus 200 may generate display images on the basis of the image data streamed from the content providing server 20. It is to be noted that the content processing apparatus 200 may be incorporated in the head-mounted display 100. Further, the manner of sharing functions between the content processing apparatus 200 and the content providing server 20 is not limited to anything specific. Moreover, in the image display system 1, the number of content processing apparatuses 200 connected to the network 8 and the number of network-connected content providing servers 20 connected thereto are not limited to any number.

For example, the content providing server 20 may acquire the movements and operations of multiple users from each content processing apparatus 200 and have what is acquired reflected in the movements of what are generally called avatars representing the users in a virtual world. In addition, the content providing server 20 may distribute three-dimensional data of the virtual world to each content processing apparatus 200. In this case, each content processing apparatus 200 generates display images from the transmitted three-dimensional data at a predetermined rate and causes the head-mounted display 100 to display the generated images. In this manner, multiple users located remotely from each other can get together, communicate with one another, and participate in one game by means of their avatars.

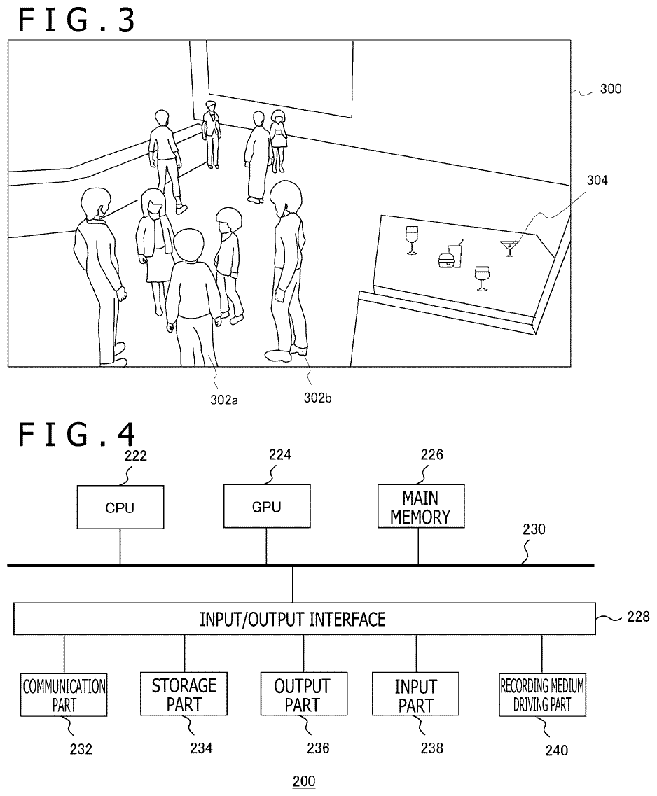

FIG. 3 depicts an exemplary image displayed on the head-mounted display 100. In this example, a display image 300 represents a virtual space including multiple avatars from a panoramic viewpoint (third-person perspective). In the real world, each user wearing the head-mounted display 100 launches an application and performs operations to participate in the virtual space provided by the content providing server 20. This causes the user's own avatar (e.g., an avatar 302a) to appear in the virtual space, allowing the user to communicate with the avatars of other participating users (e.g., an avatar 302b).

The avatar 302a of the user may move in a manner reflecting the user's movement in the real world, or may be moved by the user operating a controller, not depicted. For example, the user moves the own avatar 302a in the virtual space, talks to another avatar, or grabs an item (e.g., a glass 304) existing in the virtual space. The conversation with other avatars may be performed in real voice or in text. The processes related to the control and display of such a virtual space have been conceived of and already implemented diversely depending on the details of content and thus will not be discussed further in detail.

In any case, there are no particular limitations on the types and purposes of the virtual space to be displayed, the types of viewpoints, the presence or absence of avatars, the participation or non-participation of other users, and the like in the present embodiment. In the description that follows, the virtual space that includes user-manipulable objects exemplified by avatars will be referred to as a “VR space.” Also, the state where images representing the VR space are displayed on the head-mounted display 100 and where the user's own object or the user's viewpoint is manipulated in the VR space will be referred to as “staying in the VR space.”

In recent years, diverse places such as the workplace, meeting rooms, banquet halls, eateries, streets, and event venues have been created as a VR space such as the illustrated one in which people can stay and buy things as if in the real world. That is, the scenes for utilizing the VR space are not just limited to temporary entertainment such as electronic games but continue to expand in the real world. This trend is expected to intensify from now on.

Under such circumstances, the longer the period in which the user stays in the VR space constituting a virtual workplace or a virtual banquet hall, the higher the possibility of experiencing matters to be dealt with in the real world such as consumption of food and drink, elimination, receiving a visitor, or taking calls during that period. Every time such a necessity comes up, the user needs to remove and again wear the head-mounted display 100, which can be bothersome and reduce the quality of the user experience in the VR space.

Further, as illustrated, with regard to the VR space which provides a scene for social interaction between the users, it is not unusual to have a parallel state in which the users staying in the VR world prepare and enjoy food and drink and have conversations with each other also in the real world, for example, thus exhibiting similar behaviors in both the VR world and the real world. In this case, however, the user wearing the head-mounted display 100 and having to grope for food and drink in the real world may feel stressed unlike in the real party.

If the above-mentioned video see-through function is incorporated in the head-mounted display 100 to let the display target be switched at a desired timing, the user can at least verify the real-world situation without taking off the head-mounted display 100. However, if VR imagery is cut off by a controller, for example, the timeline in the VR space is abruptly interrupted, which can compromise its world view. Particularly in a VR space where the users interact with each other, they may have feelings of discomfort upon noticing a sudden disappearance of a participating member.

In view of this, in the present embodiment, when the action of an object in the VR space meets a predetermined condition, which is a trigger, the display on the head-mounted display 100 is switched to a real-world image. That is, a link from the VR space to the real world is set on a given object in the VR space. This extends considerably means for expressing a temporary exit of a user from the VR space where the user is staying. As a result, even when the user stays in the VR space over an extended time period, the user can deal seamlessly with matters to attend to in the real world as needed while the world view of the VR space is maintained. Further, the other users do not have a sense of strangeness when noticing an exit of the relevant user from the shared VR space.

FIG. 4 depicts an internal circuit configuration of the content processing apparatus 200. The content processing apparatus 200 includes a central processing unit (CPU) 222, a graphics processing unit (GPU) 224, and a main memory 226. These components are interconnected via a bus 230. The bus 230 is further connected with an input/output interface 228. The input/output interface 228 is connected with a communication part 232, a storage part 234, an output part 236, an input part 238, and a recording medium driving part 240.

The communication part 232 includes a peripheral device interface such as a universal serial bus (USB) interface or an Institute of Electrical and Electronics Engineers (IEEE) 1394 interface and a network interface for a wired or wireless local area network (LAN), for example. The storage part 234 includes a hard disk drive and a nonvolatile memory. The output part 236 outputs data to the head-mounted display 100. The input part 238 receives input of data from the head-mounted display 100. The recording medium driving part 240 drives a removable recording medium such as a magnetic disk, an optical disk, or a semiconductor memory.

The CPU 222 controls the content processing apparatus 200 as a whole by executing an operating system stored in the storage part 234. Also, the CPU 222 executes various programs (e.g., a VR game application and the like) read from the storage part 234 or the removable recording medium and loaded into the main memory 226 or downloaded via the communication part 232. The GPU 224 has a function of a geometry engine and a function of a rendering processor. The GPU 224 performs rendering processes in accordance with rendering instructions from the CPU 222, and outputs the result of the rendering to the output part 236. The main memory 226 includes a random access memory (RAM) and stores the programs and data necessary for processing.

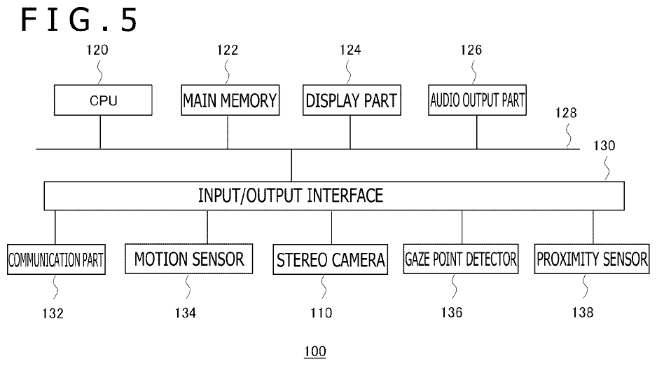

FIG. 5 depicts an internal circuit configuration of the head-mounted display 100. The head-mounted display 100 includes a CPU 120, a main memory 122, a display part 124, and an audio output part 126. These components are interconnected via a bus 128. The bus 128 is further connected with an input/output interface 130. The input/output interface 130 is connected with a communication part 132 including a wireless communication interface, a motion sensor 134, the stereo camera 110, a gaze point detector 136, and a proximity sensor 138.

The CPU 120 processes the information acquired from the components of the head-mounted display 100 via the bus 128, and supplies the display part 124 and the audio output part 126 with display image data and audio data obtained from the content processing apparatus 200. The main memory 122 stores the programs and data required by the CPU 120 for processing.

The display part 124 includes a display panel such as a liquid display panel or an organic electroluminescent (EL) panel, and displays images in front of the eyes of the user wearing the head-mounted display 100. The display part 124 may realize a stereoscopic view by displaying a pair of stereo images in regions corresponding to the right and left eyes. The display part 124 may further include a pair of lenses for expanding the user's viewing angle, the lenses being interposed between the display panel and the user's eyes when the user wears the head-mounted display 100.

The audio output part 126 includes speakers or earphones mounted at positions corresponding to the ears of the user wearing the head-mounted display 100, the speakers or earphones allowing the user to hear sound. The communication part 132 is an interface that transmits and receives data to and from the content processing apparatus 200. The communication part 132 implements communication by use of a known wireless communication technology such as Bluetooth (registered trademark). The motion sensor 134 includes a gyro sensor and an acceleration sensor, and acquires the angular velocity and acceleration rate of the head-mounted display 100.

As depicted in FIG. 1, the stereo camera 110 is constituted by a pair of video cameras for capturing images of the surrounding real space in a field of view corresponding to the user's viewpoint from left and right viewpoints. Items in the line-of-sight direction of the user (typically, directly in front of the user) are caught in the frames of moving images captured by the stereo camera 110.

The gaze point detector 136 tracks the spot gazed at by the user on the display panel of the display part 124. The gaze point detector 136 includes a mechanism that emits reference light such as infrared rays to the user's eyeballs and cameras that capture the light reflected from the eyeballs. The gaze point detector 136 thus derives the gaze point from the orientation of the pupils. It is to be noted that, in the present embodiment, as will be discussed later, the images captured by these cameras are also used to acquire the state of the eyes and eyelids.

The proximity sensor 138 detects the state in which the user wears the head-mounted display 100. Measurement by the motion sensor 134, images captured by the stereo camera 110, information regarding the eye images and the gaze point acquired by the gaze point detector 136, and information acquired by the proximity sensor 138 regarding the head-mounted display 100 being worn or taken off are transmitted as needed to the content processing apparatus 200 via the communication part 132.

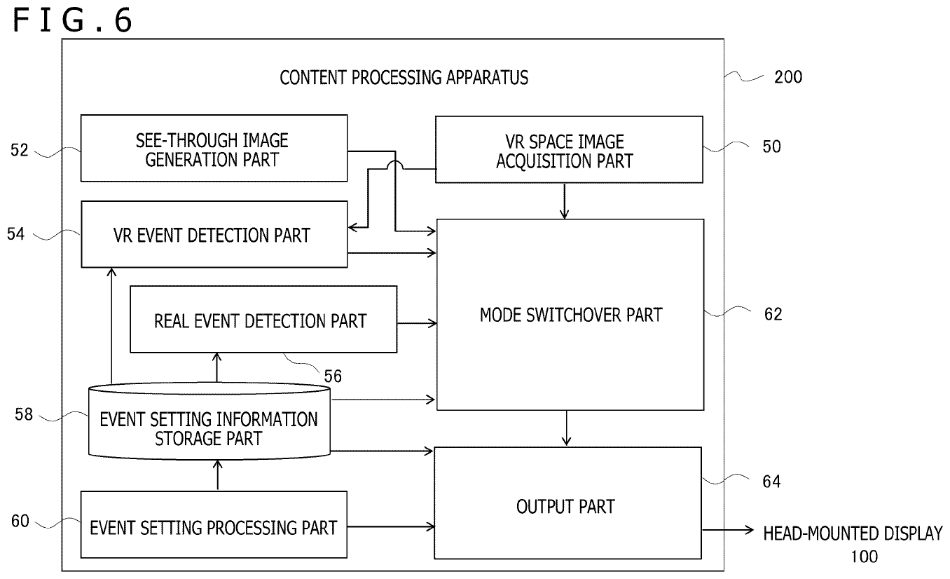

FIG. 6 depicts functional blocks of the content processing apparatus 200. It is to be noted that, as discussed above, the content processing apparatus 200 has the functions of processing, on its own, various kinds of content such as electronic games and of establishing communication with the content providing server 20 and head-mounted display 100. FIG. 6 mainly indicates the blocks of the functions related to switchover between a mode for displaying VR space images (referred to as a “VR space mode”) and the see-through mode. Of the functions of the content processing apparatus 200, those illustrated in the figure may be implemented as the display control apparatus. Further, at least some of the functions illustrated in the figure may be incorporated in the head-mounted display 100 or in the content providing server 20.

The multiple functional blocks in FIG. 6 can be implemented in a hardware configuration that includes, for example, the CPU 222, the GPU 224, the main memory 226, and the storage part 234 depicted in FIG. 4, or can be implemented by software using computer programs that implement the functions of the multiple functional blocks. It will thus be understood by those skilled in the art that these functional blocks can be implemented by hardware alone, by software alone, or by a combination of both in diverse forms and that the implementation is not limited to a particular form.

The content processing apparatus 200 includes a VR space image acquisition part 50 that acquires images representing the VR space, a see-through image generation part 52 that generates images representing the real world, a VR event detection part 54 that detects an event in the VR space from among the events triggering mode switchover, a real event detection part 56 that detects an event in the real world, an event setting information storage part 58 that stores setting information regarding an event triggering the mode switchover, an event setting processing part 60 that receives the settings of the event triggering the mode switchover from the user, a mode switchover part 62 that controls the mode switchover, and an output part 64 that outputs display images.

In the VR space mode, the VR space image acquisition part 50 acquires at a predetermined rate the display image representing the VR space, such as one illustrated in FIG. 3. The VR space image acquisition part 50 may process content on its own and generate the display image of the VR space as a result of the process, or generate the display image on the basis of information supplied from the content providing server 20 with regard to the VR space. As another alternative, the VR space image acquisition part 50 may decode or modify as needed the display image supplied from the content providing server 20, to generate the display image.

In the VR space, there exists at least a virtual object that gazes at the image representing the VR space, i.e., a virtual object manipulated by the user wearing the head-mounted display 100 to which the image is output. This virtual object is not limited to anything specific; it may be an avatar such as one of those depicted in FIG. 3, or a character or a vehicle manipulated by the user in an electronic game. In the description that follows, such a virtual object will be referred to as a “self-object.”

The display image of the VR space may be expressed from the viewpoint of the self-object (from a first-person perspective), or from some other suitable viewpoint. In the see-through mode, the see-through image generation part 52 generates at a predetermined rate the display image representing what the real world is like in real time. Specifically, the see-through image generation part 52 acquires instantaneously the moving image captured by the stereo camera 110 of the head-mounted display 100, and modifies the acquired image into the display image.

In the VR space mode, the VR event detection part 54 detects the occurrence of a predetermined event related to an object in the VR space. This event has been set as the trigger for switchover from the VR space mode to the see-through mode. For example, the VR event detection part 54 detects the self-object executing a predetermined action such as exiting from a door that exists in the VR space or grabbing an item found in the VR space.

It is to be noted that the events detected by the VR event detection part 54 are not limited to the actions belonging strictly to the self-object. The events may also be such occurrences as the self-object moving into a predetermined region in the VR space, the self-object coming into contact with a predetermined object, or the self-object doing an act that causes another object to produce a predetermined change.

As another alternative, the VR event detection part 54 may detect events caused by motions of multiple virtual objects including those of other users. The VR event detection part 54 may detect the occurrence of a predetermined event by referencing images acquired by the VR space image acquisition part 50, or by identifying changes of the self-object in the VR space on the basis of the operations or actions of the user.

The real event detection part 56 detects the occurrence of a predetermined event in the real world. For example, the real event detection part 56 detects that a predetermined state related to the user's eyes has continued for at least a predetermined time period, such as the eyelids being closed, the eyes blinking repeatedly, or the eyes gazing in a predetermined direction relative to the display screen. The movement of the user's eyelids or the position of the gaze point relative to the display screen is obtained by acquiring from the head-mounted display 100 the information regarding the captured image of the eyes or the gaze point obtained by the gaze point detector 136. Besides detecting the eye-related events, the real event detection part 56 may detect, as an event, that a part of the user's body observable by sensors, not depicted, has entered a state that meets a predetermined condition.

Further, the real event detection part 56 may detect predetermined changes occurring in the position and posture of the user in the real world. The position and posture of the user wearing the head-mounted display 100 are obtained by use of measurement taken by the motion sensor 134 of the head-mounted display 100 or the result of analyzing the images captured by the stereo camera 110. Such functions may be utilized by the real event detection part 56 to detect that the user has performed a predetermined gesture.

As another alternative, the real event detection part 56 may use a timer, not depicted, to detect the elapse of a predetermined time period following mode switchover. The real event detection part 56 may also detect the occurrence of an event upon obtaining the point in time, detected by the proximity sensor 138, at which the head-mounted display 100 is worn. Further, the real event detection part 56 may detect a predetermined operation performed by the user on an input apparatus, not depicted. Such events in the real world may be used, in combination with an event in the VR space, as the trigger for switching to the see-through mode. Alternatively, an event in the real world may be used singly as the trigger for switchover from the see-through mode to the VR space mode.

The event setting information storage part 58 stores the setting information regarding the events to be detected by the VR event detection part 54 or the real event detection part 56 as the trigger for switchover between the VR space mode and the see-through mode. The event setting information may include, for example, information set in common for all pieces of content beforehand, information set by content creators for individual pieces of content in a manner reflecting their details, and information set by individual users.

The event setting processing part 60 receives from the user the settings of the events to be detected by the VR event detection part 54 or by the real event detection part 56 as the trigger for switchover between the VR space mode and the see-through mode, and stores the received event settings as the setting information into the event setting information storage part 58. For example, the user can discretionally make the settings of the action desired to be performed by the self-object and the object related to the action as the trigger for switchover from the VR space mode to the see-through mode. This allows the user to better memorize the trigger for mode switchover and to create dramatic effects accommodating the user's intentions and preferences in the VR space.

When the VR event detection part 54 detects the occurrence of an event in the VR space, the mode switchover part 62 switches display from the VR space mode to the see-through mode. Also, when the real event detection part 56 detects the occurrence of an event in the real world, the mode switchover part 62 switches display from the see-through mode to the VR space mode. Alternatively, the mode switchover part 62 may use the occurrence of an event in the real world for switchover from the VR space mode to the see-through mode.

In VR space mode, the mode switchover part 62 acquires the data of the display image representing the VR space from the VR space image acquisition part 50, and outputs the acquired data to the output part 64. Further, in the see-through mode, the mode switchover part 62 acquires the data of the display image representing the real world generated by the see-through image generation part 52, and outputs the acquired data to the output part 64. It is to be noted that, in the see-through mode, the mode switchover part 62 may output both the data of the display image representing the VR space and the data of the display image representing the real world to the output part 64.

The output part 64 outputs the display image data output from the mode switchover part 62, to the head-mounted display for display thereon. Also, the output part 64 outputs the data of a setting screen through which the event setting processing part 60 receives event-related settings from the user, to the head-mounted display for display thereon.

In the see-through mode, the output part 64 may integrate the display image representing the real world with the display image representing the VR space to generate the final display image. For example, the output part 64 may put a real-world display image in a partial region of the display image of the VR space to generate the final display image. Alternatively, the output part 64 may overlay a translucent real-world display image onto a VR space display image background to generate the final display image.

The output part 64 may change the audio data output to the head-mounted display 100, upon display mode switchover. For example, the output part 64 may output the audio of the VR space in the VR space mode, and output the voice and environmental sound of the real world in the see-through mode. As another alternative, in the see-through mode, the output part 64 may lower the volume of the sound in the VR space to let the voice and environmental sound of the real world reach directly the user's ears.

Further, in the see-through mode, the output part 64 may output to the head-mounted display 100 the audio from such devices as a mobile phone used by the user in the real world. For example, in a case where the user selects the see-through mode to speak on the phone, the output part 64 may communicably connect to the phone to acquire audio data from the communicating party in the call, and output the acquired audio data to the head-mounted display 100. This enables the user still wearing the head-mounted display 100 to have a call with a party unrelated to the VR space.

In order to implement the embodiment described above, preferably, the event to be detected by the VR event detection part 54 is set in consideration of the purpose of switching from the VR space mode to the see-through mode. For example, in a case where the action of answering an incoming call or placing a call in the real world is purposed for switching to the see-through mode, the action of the self-object grabbing a virtual phone as an object in the VR space is set as the event to be detected.

In this manner, associating the action of the self-object in the VR space with the user's own action in the real world permits intuitive operations and reduces the possibility of compromising the world view of the VR space due to a sudden incoming call. It is to be noted that, in this case, when the content processing apparatus 200 acquires from the phone a notification of an incoming call, the VR space image acquisition part 50 may change the display image of the VR space in a manner indicating the incoming call in the VR space. For example, the VR space image acquisition part 50 may flash a virtual phone indicator in the VR space to represent the incoming call in the real world.

When the self-object grabs the object of the virtual phone in the VR space, the mode switchover part 62 switches to the see-through mode, and notifies the output part 64 of the details of the event that has occurred. This allows the output part 64 in the see-through mode to recognize that the audio output is switched to the voice of the communicating part, on the basis of the setting information. When the event to be detected in the VR space is associated beforehand with the handling of audio data upon switching to the see-through mode, it is possible to control not only the voice of the communicating partner but also the above-described audio output.

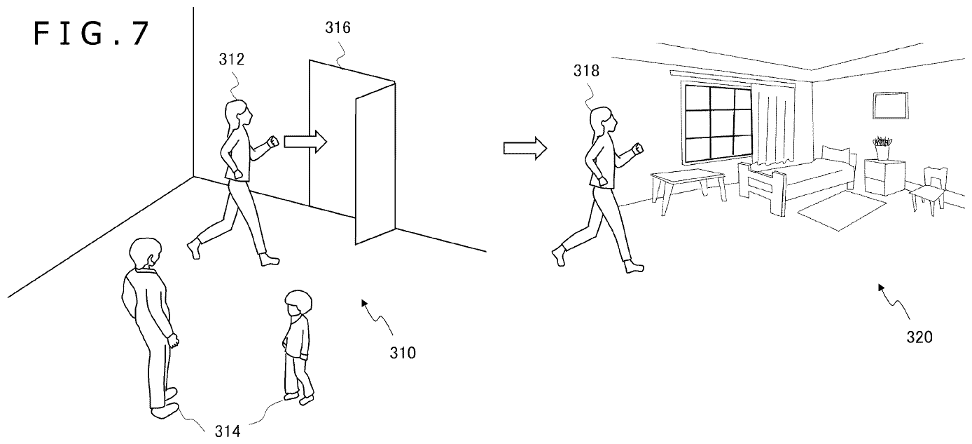

FIG. 7 is a view depicting a perceptive image of a manner of switchover from the VR space mode to the see-through mode, the switchover being triggered by an event in the VR space. The user staying in a VR space 310 manipulates a self-object 312 to communicate with another object 314 or to participate in an electronic game. In the process, it may occur to the user that there is a matter to attend to in the real world. In that case, the user moves the self-object 312 to the proximity of a door 316 set as the trigger for mode switchover.

When the relation between the door 316 and the self-object 312 meets a predetermined condition, the VR event detection part 54 determines that an event has occurred. For example, the VR event detection part 54 determines that the predetermined condition is satisfied when the self-object 312 enters any one of states including a state in which the self-object 312 comes into a predetermined range around the door 316, a state in which the self-object 312 comes into contact with the door 316, a state in which the self-object 312 performs the action of opening the door 316, and a state in which the self-object 312 goes out of the door 316.

Whether a contact has occurred between the self-object 312 and some other object such as the door 316 can be determined by application of what is generally called a collision detection technique in which calculations using a bounding box, for example, are performed to determine whether collision has taken place between objects in a common electronic game. The display of the VR space depicts the self-object 312 exiting from the door 316. In the case of a VR space where multiple users are staying, an action like this of the self-object 312 is reflected by the content providing server 20 in three-dimensional information regarding the VR space, the information being distributed to the content processing apparatus 200 of each user for visual recognition.

At the time when the VR event detection part 54 determines the occurrence of the event related to the door 316, the content processing apparatus 200 of the user manipulating the self-object 312 causes the mode switchover part 62 to switch to the see-through mode. This allows the head-mounted display 100 of the user to display a real-time image of the real world captured by the stereo camera 110. FIG. 7 depicts what it is like in the own room 320 (of a user 318) of the real world.

Such display changes enable the user to have a sensation of moving from the VR space 310 to the own room 320 through the door 316. This makes it possible for the user to feel that the world of the VR space 310 continues without interruption while attending to matters in the real world in the see-through mode. The extent of compromising the world view of the VR space or spoiling the fun for the user is reduced considerably. In addition, the other users staying in the VR space can recognize the exit of the user of the object 312 in an intuitive manner.

It is to be noted that the door 316 as the trigger for mode switchover may be replaced by, for example, a bathroom door or an emergency exit in the VR space. For example, if the user feels having to go to the bathroom in the real world, the user may cause the self-object 312 to go to the bathroom in the VR space so as to switch to the see-through mode. In the user's consciousness, there is thus a seamless connection between the VR space and the real world. It is to be noted that, although the self-object 312 and the user 318 have the same appearance in FIG. 7, needless to say, the self-object 312 may alternatively be a distorted character in the VR space.

Further, the mode switchover part 62 may switch from the see-through mode back to the VR space mode when a predetermined condition is met regarding any one of the above-described items detectable by the real event detection part 56; such items include the user's body part such as the eyes, the position and posture of the user, an elapsed time, the state of the head-mounted display 100 being worn, and operations on the input apparatus. For example, when the real event detection part 56 detects, as an event, that the user goes to the bathroom while wearing the head-mounted display 100 and returns to the own room, the user's movement in the real world connects seamlessly to the return to the VR space.

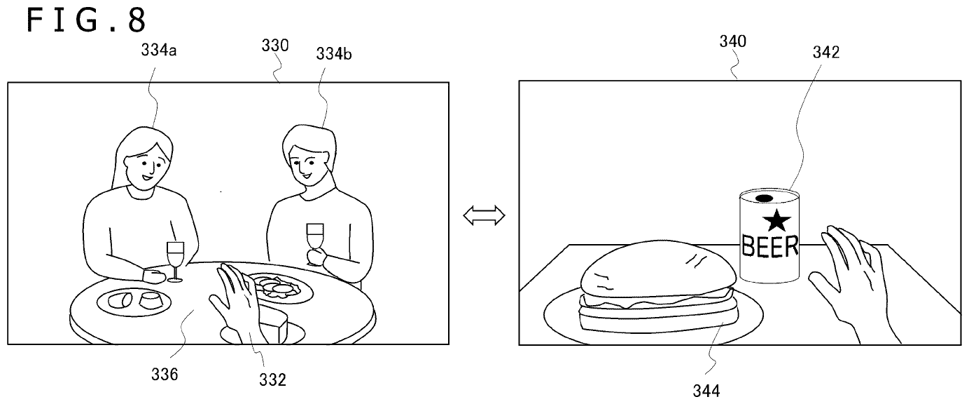

FIG. 8 depicts another example of a manner of switchover from the VR space mode to the see-through mode, the switchover being triggered by an event in the VR space. In this example, a case of representing a VR space where the user is having a party with other users as viewed from a first-person perspective is assumed. A display image 330 thus excludes the face and the like of the self-object and indicates only a hand 332 of the self-object along with objects 334a and 334b as the other users in this example. Obviously, the display images for the other users exhibit the object of the relevant user looking at the display image 330.

The self-object may be caused to behave as if consuming food and drink placed on a virtual table while communicating by real voice and the like with the other participating members. In this manner, a state similar to that of the real party is created in the virtual world. Meanwhile, each user may prepare foods and drinks within their reach in the real world when taking part in the party in the VR space. This allows the users to actually enjoy eating and drinking, thereby boosting the festive mood of the party.

It is assumed here that a glass 336 in the VR space is set as the trigger for mode switchover. When the relation between the glass 336 and the self-object (the hand 332) meets the predetermined condition involving the glass 336 getting grabbed by the self-object, the VR event detection part 54 determines that an event has occurred. The above-mentioned collision detection technique, for example, can also be applied to this case.

At the time when the event related to the glass 336 is determined to have occurred, the content processing apparatus 200 of the user looking at the display image 330 causes the mode switchover part 62 to switch to the see-through mode. This allows the head-mounted display 100 of the user to display a real-world image 340 captured in real time by the stereo camera 110. The user can view, grab by hand, and consume food 342 and drink 344 prepared in the real world, so that there is no stress or hazard associated with fumbling.

The manner described above has the purpose of permitting eating and drinking in the real world without burdening or jeopardizing the user. That often means a few seconds or so is enough for the stay in the see-through mode. Thus, even if the self-object is not made to exit from the VR space, unlike the case in FIG. 7, the other users are not very likely to have a sense of strangeness. As a result, the convenience of eating and drinking in the real world can be improved for the user viewing the display image 330 as well as for the other users while the world view of the VR space is maintained.

With the above characteristics taken into account, the mode switchover part 62 may count the time following the switchover to the see-through mode and, upon elapse of a predetermined time period, return automatically to the VR space mode. In this case, given that there are differences in the time required to verify and consume different kinds of foods and drinks, the objects set as the trigger for mode switchover may be differentiated by the type of actual food and drink. The mode switchover part 62 may change the time period in which the see-through mode is maintained, depending on the type of the object as the trigger.

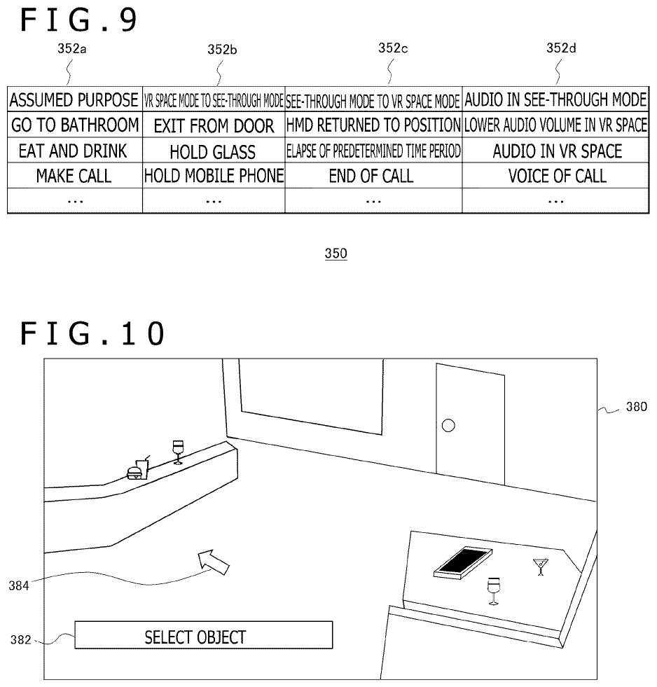

FIG. 9 depicts an exemplary data structure of the setting information stored in the event setting information storage part 58. Event setting information 350 has a structure in which each assumed purpose 352a is associated with an event 352b as the trigger for switchover from the VR space mode to the see-through mode, with an event 252c as the trigger for switchover from the see-through mode back to the VR space mode, and with details 352d of audio control in the see-through mode. It is to be noted that the assumed purposes 352a are used as the preconditions for setting the other items.

A setting example in the second row assumes that the user goes to the bathroom. The exit of the self-object from the door in the VR space is set as the trigger for switching to the see-through mode. The return of the head-mounted display 100 to its initial position is set as the trigger to return to the VR space mode. In this case, the volume of the audio in the VR space is lowered in the see-through mode such that the sound in the real world will be easier to listen to.

A setting example in the third row assumes that the user consumes food and drink while staying in the VR space. The self-object grabbing a glass in the VR space is set as the trigger for switching to the see-through mode. The elapse of a predetermined time period is set as the trigger to return to the VR space mode. In this case, in the see-through mode, the volume of the audio in the VR space is left unchanged such that conversations in the virtual party or the like will continue.

A setting example in the fourth row assumes that the user makes a call on the phone in the real world. The self-object grabbing a mobile phone in the VR space is set as the trigger for switching to the see-through mode. Ending the call is set as the trigger for returning to the VR space mode. The end of the call may be detected either by the content processing apparatus 200 receiving a notification to that effect from the phone or upon occurrence of a predetermined event such as a gesture made by the user. In this case, the voice of the communicating party in the call in the see-through mode is acquired from the phone and output such that the user can speak while wearing the head-mounted display 100.

It is to be noted that the setting details and the data structure of the event setting information 350 in FIG. 9 are only examples and may be replaced by specific values, subdivided into more detailed items, or omitted in some items. Also, although only the events occurring in the VR space are set as the trigger for switchover from the VR space mode to the see-through mode in the illustrated example, this is not limitative of how the present invention is embodied.

That is, events in the real world, such as the user's body part, the position and posture of the user, and operations on the input apparatus, may be used also as the conditions for switchover from the VR space mode to the see-through mode. As another alternative, conditions may be set for the events in both the VR space and the real world such that, when the conditions for both worlds are met simultaneously, switchover from the VR space mode to the see-through mode is performed.

As discussed above, at least part of the event setting information 350 may be set discretionally by the user. For example, the time having to go to the bathroom to leave the virtual space or the time needed to eat and drink varies depending on the individual users. Thus, in particular, in a case where the elapsed time after the switchover to the see-through mode is used as the condition for switching to the VR space mode, the user may discretionally set that time. This reduces the stress stemming from an excessively prolonged or unduly short see-through mode.

FIG. 10 depicts an exemplary setting screen displayed by the event setting processing part 60 for receiving event-related settings from the user. Because the assumed purpose of exiting a mode and the object that can be used as the trigger for mode switchover vary depending on the type and details of VR space, the event setting processing part 60 may preferably receive the user settings specific to each VR space actually created. A setting screen 380 in FIG. 10 assumes the presence of the VR space illustrated in FIG. 3.

The event setting processing part 60 displays an image that represents the structure of a given VR space and the objects therein as the setting screen 380 for the user who participates in this VR space for the first time or for the user who requests changes in the setting details. The event setting processing part 60 may change as needed the viewpoint of the VR space displayed on the setting screen 380, in accordance with the user's operations to change the viewpoint. Further, the event setting processing part 60 displays a message 382 “Select object” and a cursor 384 operable by the user in an overlaid manner.

Using the message 382, the event setting processing part 60 prompts the user to select from the screen the object to be set as the trigger for switchover from the VR space mode to the see-through mode. Using the cursor 384, the user selectively designates the object to be set as the trigger from among various objects displayed on the setting screen 380. The event setting processing part 60 receives the designated object and adds it to the setting information stored in the event setting information storage part 58.

In practice, the event setting processing part 60 may receive user settings with respect to various items such as those indicated in FIG. 9. When the user discretionally sets the event constituting the trigger for mode switchover, it is possible to implement the switchover more easily. This also makes it easier to memorize the event required for the switchover. Depending on how the settings are made, it is also possible to execute the switchover to the see-through mode in an entertaining manner.

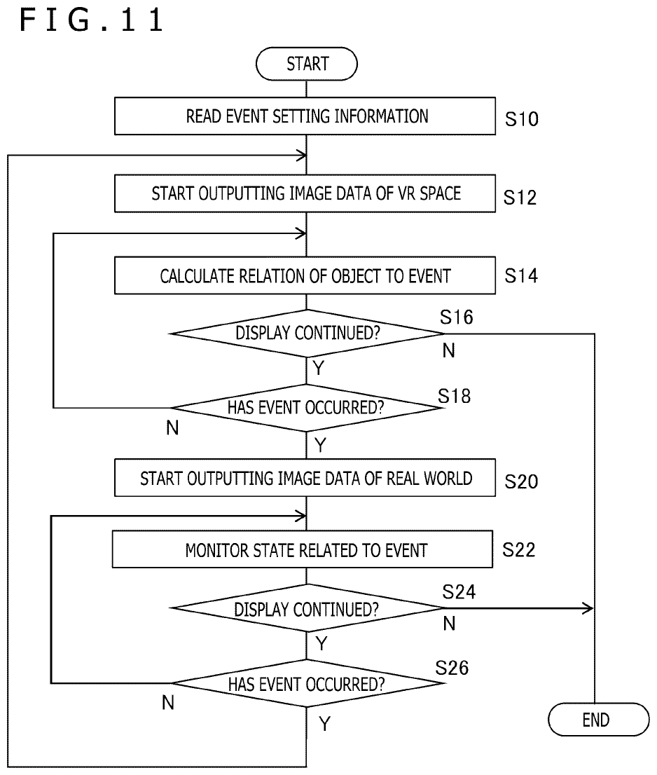

Explained below are the operation of the content processing apparatus 200 implemented in the above-described configuration. FIG. 11 is a flowchart of processing steps performed by the content processing apparatus for controlling switchover between the VR space mode and the see-through mode. For example, this flowchart is started when the user wears the head-mounted display 100 and performs operations to request participation in the VR space. In response, the VR space image acquisition part 50 acquires VR space-related data typically from the content providing server 20 to generate display images consecutively.

Meanwhile, the VR event detection part 54, the real event detection part 56, the mode switchover part 62, and the output part 64 read the setting information related to the event from the event setting information storage part 58 (S10). The mode switchover part 62 acquires the image data representing the VR space from the VR space image acquisition part 50, and supplies the acquired data to the output part 64. This causes the output part 64 to start outputting the data to the head-mounted display 100 (S12). The VR event detection part 54 monitors the occurrence of the event that has been set as the trigger for switchover from the VR space mode to the see-through mode (S14).

For example, the VR event detection part 54 determines, at a predetermined rate, whether the event has occurred or not, by calculating the position of the object in contact with other objects or within the VR space and matching what is calculated against the condition set as the occurrence of the event. During a period in which the display is not terminated by the user ending the application, for example (Y in S16), the VR event detection part 54 keeps monitoring the occurrence of the event (N in S18). Alternatively, as discussed above, the real event detection part 56 may also monitor the occurrence of the event in the real world in S14 and use the occurrence of the event for the basis of mode switchover.

When the VR event detection part 54 detects the occurrence of the event (Y in S18), the mode switchover part 62 switches the display to the see-through mode (S20). Specifically, the see-through image generation part 52 generates a display image representing the real world. The mode switchover part 62 acquires the data thus generated and supplies the output part 64 therewith. This causes the output part 64 to start outputting the data to the head-mounted display 100. At this point, on the basis of the event setting information, the output part 64 may modify the audio being output to the head-mounted display 100.

In the see-through mode, the real event detection part 56 monitors the occurrence of the event that has been set as the trigger for switchover from the see-through mode to the VR space mode (S22). For example, the real event detection part 56 determines, at a predetermined rate, whether or not a predetermined condition is met regarding at least one of such items as the state of the user's body part, the position and posture of the user, an elapsed time, the user's operations on the input apparatus, and the state of the head-mounted display 100 being worn.

During a period in which the display is not terminated by the user ending the application, for example (Y in S24), the real event detection part 56 keeps monitoring the occurrence of the event (N in S26). When the real event detection part 56 detects the occurrence of the event (Y in S26), the mode switchover part 62 switches the display to the VR space mode by resuming the output of VR space image data (S12). Thereafter, the above steps are similarly repeated. When it becomes necessary to stop the display in the VR space mode or in the see-through mode because the user has terminated the application, for example, the processing is brought to an end (N in S16, N in S24).

In the above-described embodiment involving the techniques for implementing VR using a head-mounted display, the event to be detected is set for an object or for its movement in the VR space. When that event has occurred, display is switched to an image that represents the real world. This enables the user while wearing the head-mounted display to deal with matters to attend to in the real world, such as eating and drinking, elimination, or receiving a visitor. As a result, the annoyance of wearing and taking off the head-mounted display is reduced. This leads to lowering psychological barriers to wearing the head-mounted display and, by extension, to the participation in the VR space.

Further, the entrance to the real world is created on the side of the VR space. This allows the user to have the sensation of continuously experiencing the virtual world in the VR space while still in the real world, which reduces the possibility of compromising the world view of the VR space. Moreover, the event as the trigger for mode switchover, the condition for switching the display from the real world back to the VR space, and the details of audio control is changed depending on the purpose of switching the display. This makes it possible for the user to attend to matters in the real world without stress and to alternate between the VR space and the real world more naturally and seamlessly in the user's consciousness. Furthermore, any user's exit from a VR space participated in by multiple users can be recognized by the remaining users from the occurrence of the exit in the VR space, so that they can continue their stay in the VR space without having a sense of strangeness.

As described above, the present invention can be applied to various information processing apparatuses including game machines, head-mounted displays, and personal computers as well as to image display systems incorporating any one of these apparatuses.

### INDUSTRIAL APPLICABILITY

The present invention relates to a display control apparatus and a display control method for controlling display on a head-mounted display.

### REFERENCE SIGNS LIST

1: Image display system
50: VR space image acquisition part
52: See-through image generation part
54: VR event detection part
56: Real event detection part
58: Event setting information storage part
60: Event setting processing part
62: Mode switchover part
64: Output part
100: Head-mounted display
200: Content processing apparatus

1. A display control apparatus comprising:
one or more processors; and
a memory storing computer-readable instructions that, upon execution by the one or more processors, configure the display control apparatus to:
output data of an image representing a virtual space to a head-mount display (HMD);
detect that a predetermined event related to a virtual object in the virtual space has occurred; and
switch, upon occurrence of the event, data to the HMD from the data of the image representing the virtual space to data of a see-through image representing a real world.

2. The display control apparatus according to claim 1,
wherein the display control apparatus is further configured to detect the occurrence of the predetermined event upon an action of the virtual object manipulated by a user wearing the HMD.

3. The display control apparatus according to claim 1,
wherein the display control apparatus is further configured to output audio data in the virtual space to the HMD and, further configured to change a manner of outputting the audio data while outputting the data of the see-through image.

4. The display control apparatus according to claim 3, wherein,
upon the occurrence of the event, wherein the display control apparatus is further configured to change the manner of outputting the audio data while outputting the data of the see-through image.

5. The display control apparatus according to claim 1, wherein the display control apparatus is further configured to detect that a predetermined event has occurred in the real world,
wherein the display control apparatus is configured to switch the data to be output back to the data of the image representing the virtual space when the predetermined event occurs in the real world.

6. The display control apparatus according to claim 5, wherein,
according to details of the event in the virtual space, the display control apparatus is configured to change the event in the real world.

7. The display control apparatus according to claim 5,
wherein the display control apparatus is configured to determine that the event has occurred in the real world, when a predetermined condition is met with respect to at least either a state of a body part of the user, a position and a posture of the user, a state of the HMD being worn, or an elapsed time.

8. The display control apparatus according to claim 2,
wherein the display control apparatus is configured to detect, as the predetermined event, that the virtual object has exited from a door that exists in the virtual space.

9. The display control apparatus according to claim 2,
wherein the display control apparatus is configured to detect, as the predetermined event, that the virtual object has grabbed an item placed in the virtual space.

10. The display control apparatus according to claim 4,
wherein the display control apparatus is configured to detect that the virtual object has grabbed a mobile phone in the virtual space, and,
the display control apparatus is further configured to output audio data of a communicating party on a phone in the real world to the HMD while outputting the data of the see-through image.

11. The display control apparatus according to claim 1, the display control apparatus is further
configured to receive an operation performed by the user to set details of the predetermined event.

12. A display control method comprising:
outputting data of an image representing a virtual space to an HMD;
detecting that a predetermined event related to a virtual object in the virtual space has occurred; and
switching, upon occurrence of the event, data to the HMD from the data of the image representing the virtual space to data of a see-through image representing a real world.

13. A non-transitory, computer readable storage medium containing a computer program which, when executed by for a computer, causes the computer to carry out a display control method, comprising:
outputting data of an image representing a virtual space to an HMD;
detecting that a predetermined event related to a virtual object in the virtual space has occurred; and
switching, upon occurrence of the event, data to the HMD from the data of the image representing the virtual space to data of a see-through image representing a real world.

14. The method of claim 12, further comprising detecting the occurrence of the predetermined event upon an action of the virtual object manipulated by a user wearing the HMD.

15. The method of claim 12, further comprising:
outputting audio data in the virtual space to the HMD; and
changing a manner of outputting the audio data while outputting the data of the see-through image.

16. The method of claim 12, further comprising:
detecting that a predetermined event has occurred in the real world; and
switching the data to the HMD back to the data of the image representing the virtual space when the predetermined event occurs in the real world.

17. The method of claim 12, further comprising receiving an operation performed by the user to set details of the predetermined event.

18. The non-transitory, computer readable storage medium of claim 13, the display control method further comprising detecting the occurrence of the predetermined event upon an action of the virtual object manipulated by a user wearing the HMD.

19. The non-transitory, computer readable storage medium of claim 13, the display control method further comprising:
outputting audio data in the virtual space to the HMD; and
changing a manner of outputting the audio data while outputting the data of the see-through image.

20. The non-transitory, computer readable storage medium of claim 13, the display control method further comprising:
detecting that a predetermined event has occurred in the real world; and
switching the data to the HMD back to the data of the image representing the virtual space when the predetermined event occurs in the real world.
